(19) United States
(12) Patent Application Publication
(10) Pub. No.: US 2014/0338935 A1
(43) Pub. Date: Nov. 20, 2014

(54) TILLAGE TOOL WITH AUTO-RESET LINKAGE AND METHOD OF USE

(71) Applicant: BIGHAM BROTHERS, INC., Lubbock, TX (US)

(72) Inventors: Von D. Kimball, Ransom Canyon, TX (US); Jimmy D. Gray, JR., Lubbock, TX (US)

(73) Assignee: BIGHAM BROTHERS, INC., Lubbock, TX (US)

(21) Appl. No.: 14/281,748

(22) Filed: May 19, 2014

Related U.S. Application Data
(60) Provisional application No. 61/824,531, filed on May 17, 2013.

(51) Int. Cl. A01B 61/04

(52) U.S. Cl. CPC A01B 61/046
USPC 172/1; 172/264

(57) ABSTRACT

A tillage with an auto-reset mechanism and system adapted for tripping when a tool encounters an obstacle in the field, and automatically resetting when the obstacle is cleared. The mechanism is adapted for mounting various ground-working tools, such as shank-mounted chisels, which typically operate slightly below the ground surface and are thus susceptible to damage from submerged obstacles, such as rocks, buried timber and tree roots.

### CROSS REFERENCE TO RELATED APPLICATION

This application claims priority in U.S. Provisional Patent Application Ser. No. 61/824,531, filed May 17, 2013, which is incorporated herein.

### BACKGROUND OF THE INVENTION

1. Field of the Invention

The present invention relates generally to tillage equipment and in particular to a ganged, strip till tool with linkage for automatically resetting after encountering an obstacle in the field.

2. Description of the Related Art

Tillage tools perform various cultivating tasks, including tilling and soil-loosening for better crop growing conditions and increased water holding capacity, firming and preparing seedbeds for optimum planting results and applying agricultural chemicals, such as fertilizer, herbicides and pesticides. Tillage tools also handle crop residues. Multipurpose tools can simultaneously open furrows, loosen soil, clear residue and close furrows over seed and field-applied chemicals. For example, tillage tools commonly include tillage shanks and knives, which operate below the field surface. Such shanks and knives are subjected to relatively extreme wear conditions, which can damage the knives and shanks themselves, as well as the equipment. Moreover, subsoil loosening of hardpan layers can improve water infiltration and absorption, encourage root development and allow for deeper fertilizer placement. The lifting action of subsoil loosening will generally not mix topsoil with subsoil, create clods, bury residue or require additional tillage operations. Conventional ripper-type plows, on the other hand, can require multi-pass field operations for effectiveness. Proper soil loosening with the appropriate equipment including properly-selected coulters, discs, knives and chisels can result in single-pass (per growing season) tilling operations, with resultant cost-savings and greater operating efficiencies.

Effective tillage is best achieved by continuously maintaining the shanks, knives, coulters, discs and other field-working equipment in their soil-penetrating, operating positions. However, subsurface obstacles, such as rocks, debris and tree roots, can damage shanks and knives and otherwise interfere with equipment operation. Various systems have been devised for accommodating such obstacles and maintaining efficient operation. Moreover, the implements and systems should be protected from breakage and other damage when immovable objects are encountered in the field.

Heretofore there has not been available a tillage tool including an auto-reset trip mechanism with the advantages and features of the present invention.

### SUMMARY OF THE INVENTION

In the practice of an aspect of the present invention, a tillage tool is provided with an auto-reset mechanism and system adapted for tripping when a tool encounters an obstacle in the field, and automatically resetting when the obstacle is cleared. The mechanism is adapted for mounting various ground-working tools, such as shank-mounted chisels, which typically operate slightly below the ground surface and are thus susceptible to damage from submerged obstacles, such as rocks, buried timber and tree roots.

### BRIEF DESCRIPTION OF THE DRAWINGS

FIG. 1 is an isometric diagram of an implement with multiple tillage tool gangs, each including an auto-reset mechanism embodying an aspect of the present invention.

FIG. 2 is a partial, exploded, isometric diagram of the tillage tool gang.

FIG. 3 is a partial, isometric diagram of a tillage tool gang equipped with the auto-reset mechanism.

FIGS. 4-11 are side elevational views of the tillage tool and the auto-reset mechanism showing a sequence of operation wherein a submerged field obstacle is encountered, a ground-working tool (e.g., a shank/knife assembly) encounters the obstacle, the auto-reset mechanism is tripped to raise the tool over the obstacle and the mechanism automatically resets with the tool again submerged in its working position.

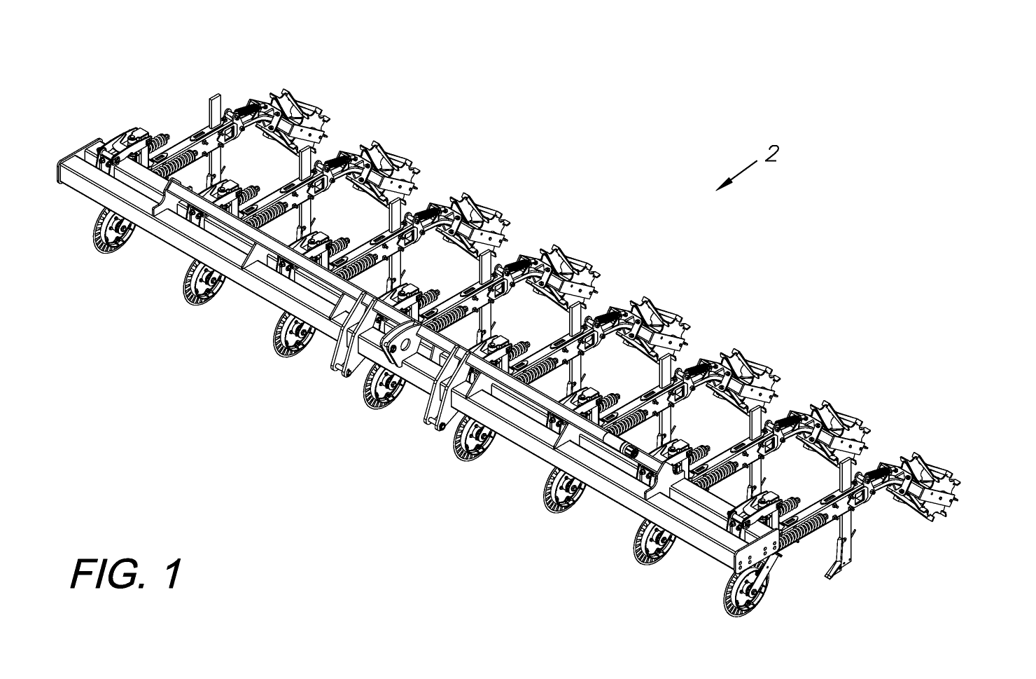

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning

### II. Tillage Tool 2

Referring to the drawings in more detail, the reference numeral 2 generally designates an implement, e.g., a multi-gang tillage tool, embodying an aspect of the present invention and generally including numerous tilling tool arm assemblies 4 with auto-reset mechanisms 8. Without limitation on the generality of useful applications of the present invention, the implement 2 can comprise a tillage tool assembly 4 including coulters, discs, knives, chemical applicators and other ground-working equipment components 10, 12, which can be chosen for particular tasks associated with factors such as field conditions, crops, ground moisture, field trash, debris, etc. The tillage tool generally includes a toolbar 22, which can be connected to a tractor by a conventional three-point hitch, a drawbar or other suitable connection mechanisms. The toolbar 22 mounts one or more “gangs” of ground-working tool arm assemblies 4. Without limitation, the multiple gangs correspond to the rows of crops in an agricultural field which are treated in a single pass. For example, eight-gang tillage tools are relatively common. Greater working widths corresponding to more crop rows can be accommodated with other aspects of the present invention, such as a stack-fold and flat-fold configurations, which can include a center section and two side sections configured for hydraulically folding up and over the center section.

A tool arm assembly 4 includes an arm 18 with a first, proximal section 15 and a second, distal section 17, which can be joined at a 90° elbow 19. Other possible configurations of the arm 18 include different angles between the sections and different arm geometries. Various configurations and shapes of the arm 18 could be functional in the tool arm assembly 4, provided similar connections to other components, geometries and ranges-of-motion are maintained. An auto-reset mechanism or system 8 includes a bracket subassembly 20 pivotally mounting the tool arm assembly proximal section 15 on the toolbar 22 for swinging upwardly to clear obstructions, and thereafter automatically resetting to a working, subsurface-engaging position. The bracket assembly 20 includes a bracket mount 26 with a pair of bracket mount plates 27, which are positioned in spaced relation and notched to receive the toolbar 22. The bracket mount 26 is mounted on the toolbar 22 by U bolts 28 for removal and reinstallation if needed. Alternatively, the bracket mounts 26 could be welded onto the toolbar 22 in fixed positions, or mounted using some other suitable attachment means. An upper linkage arm subassembly 30 includes a pair of linkage arms 31 pivotally connected at their front ends to the upper ends of the bracket mount plates 27 by a front pivot bolt 34. The linkage arms 31 are pivotally connected at their back ends to the upper end of the arm proximate section 15 by a rear pivot bolt 36. The tool arm 18 is thus adapted to pivot about a pivotal axis through the rear pivot bolt 36.

A reset spring assembly 24 includes a spring mounting bracket 32 pivotally attached to a lower end of the arm proximate section 15 by a bolt retainer 40. The spring mounting bracket 32 includes a pair of coil springs 42 each mounted on a respective side of the arm proximal section 15. The springs 42 are linked to the front bracket mount 26 by a pair of torsion rods 44, which are pivotally connected at their front ends to the bracket mount 26 lower end and extend through respective spring guides 46 at their back ends, which threadably receive nuts 48 whereby spring tension is adjustable. Suitable pivot bushings 50 can be provided at the pivotal connections for reducing friction and wear on the moving parts. Alternatively, the pivotal connections could utilize other bearing devices, configurations and/or lubricants.

A variety of tools can be mounted on the tool arm assemblies 4 for specific agricultural operations. Without limitation, knives 14 are mounted on shanks 13 extending through shank receivers 29 located on the arm distal sections 17. Each arm proximal section 15 also mounts a depth gauge wheel 12 which extends forwardly and downwardly from a wheel mounting plate 58 on the elbow 19 formed by the arm sections 15 and 17. The depth gauge wheel 12 can mount an optional coulter disk 62. A pair of row cleaners 10 is mounted between the depth gauge wheels 12 and the shanks 13.

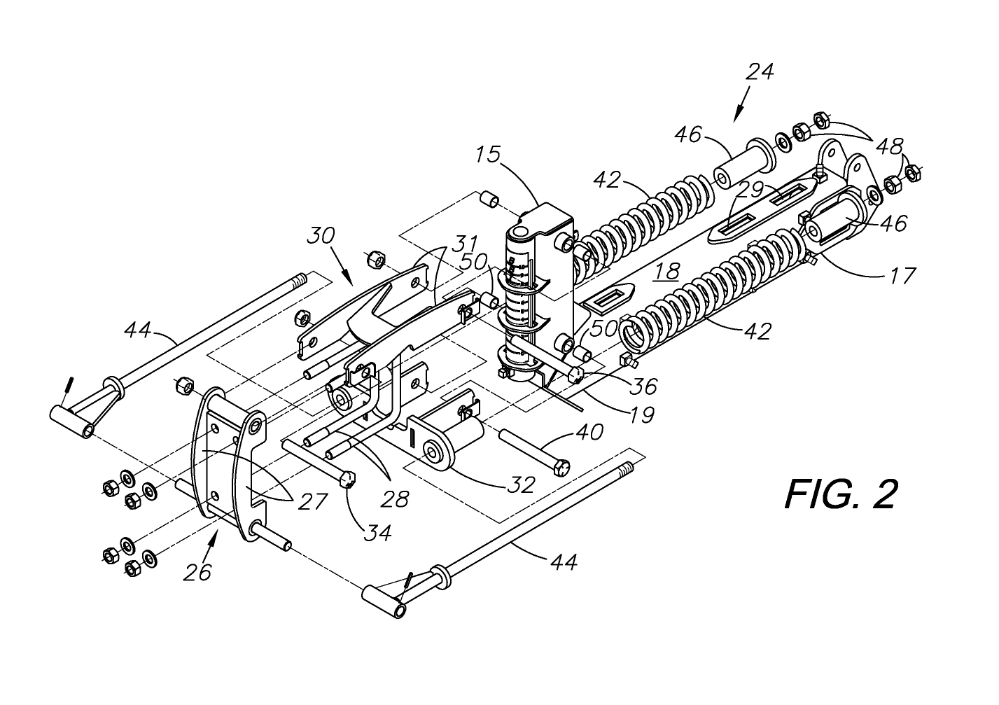

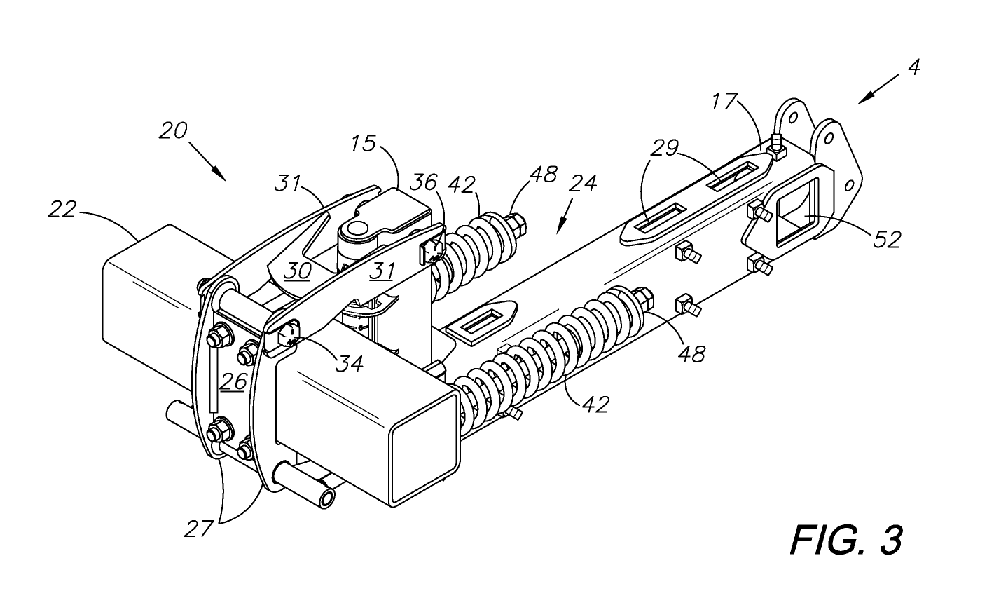

FIGS. 2 and 3 show a tool arm assembly 4 in exploded and constructed views, respectively. The elements are combined for easy disassembly for cleaning or modification, such as attaching different tool types.

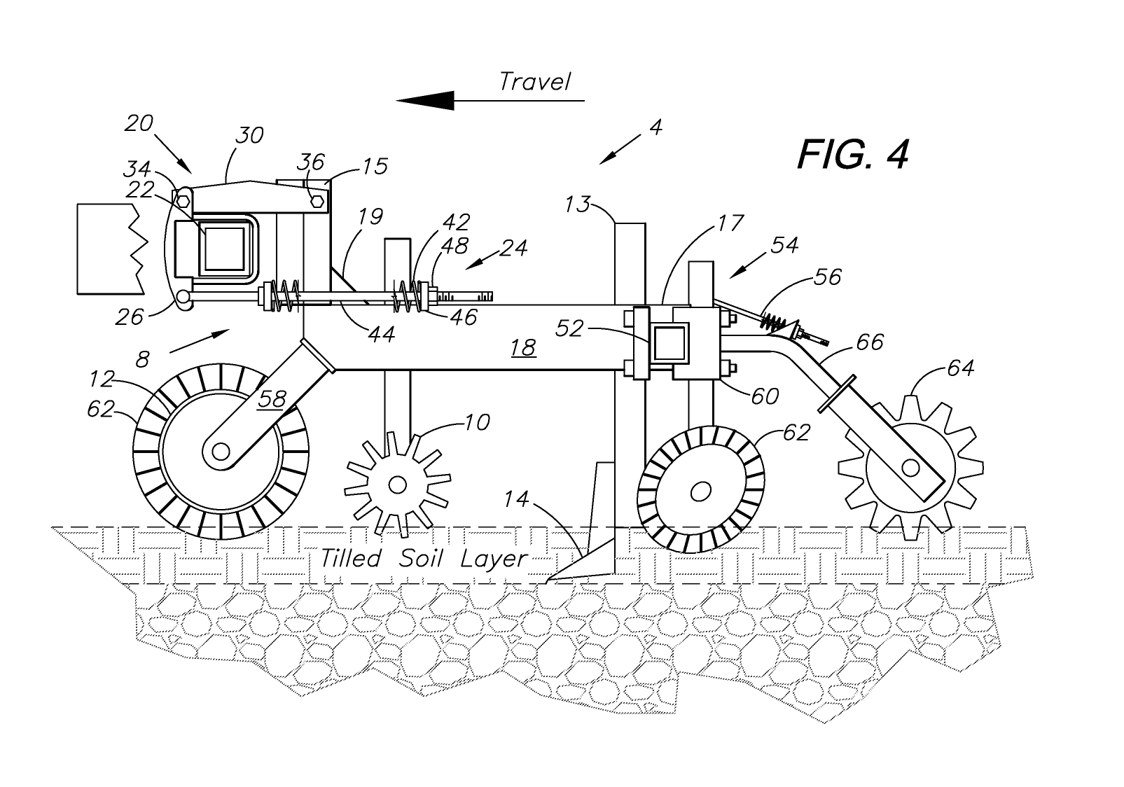

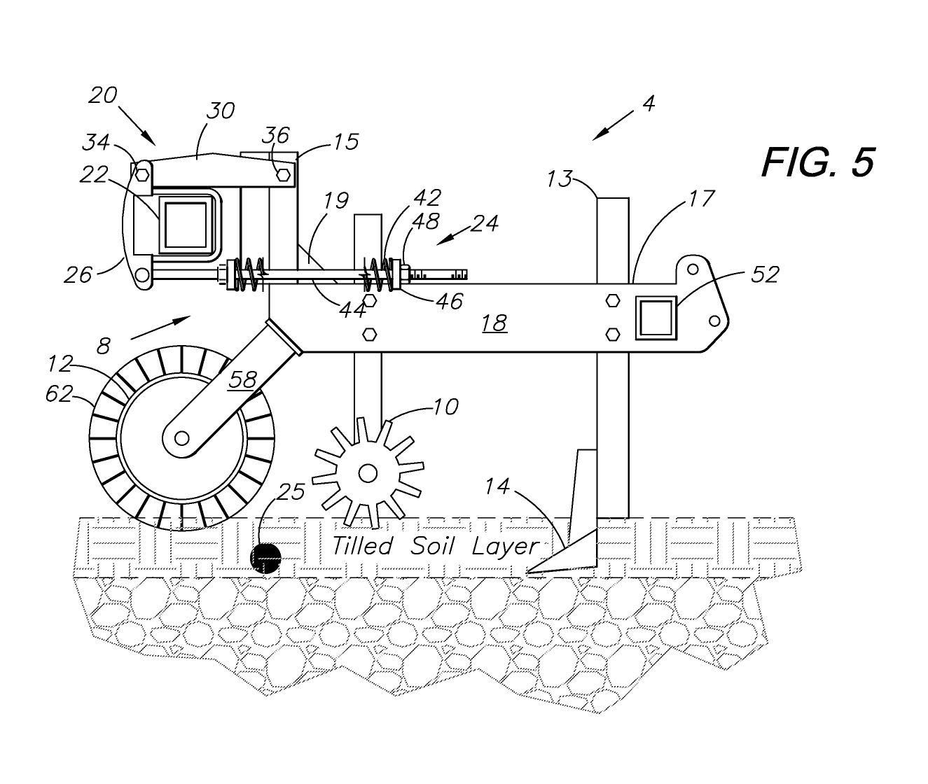

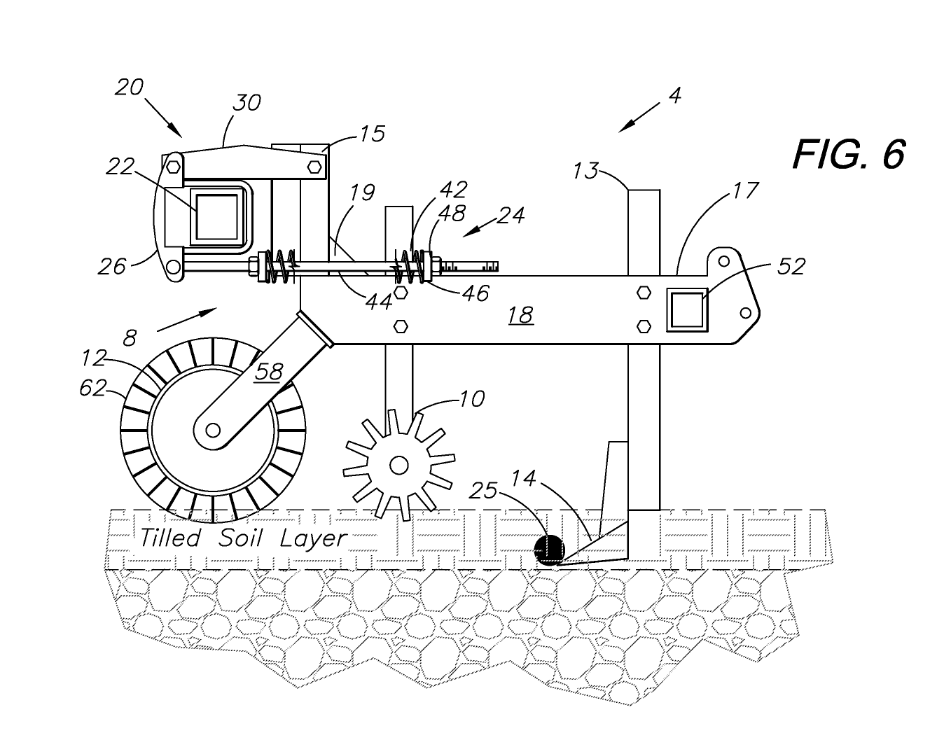

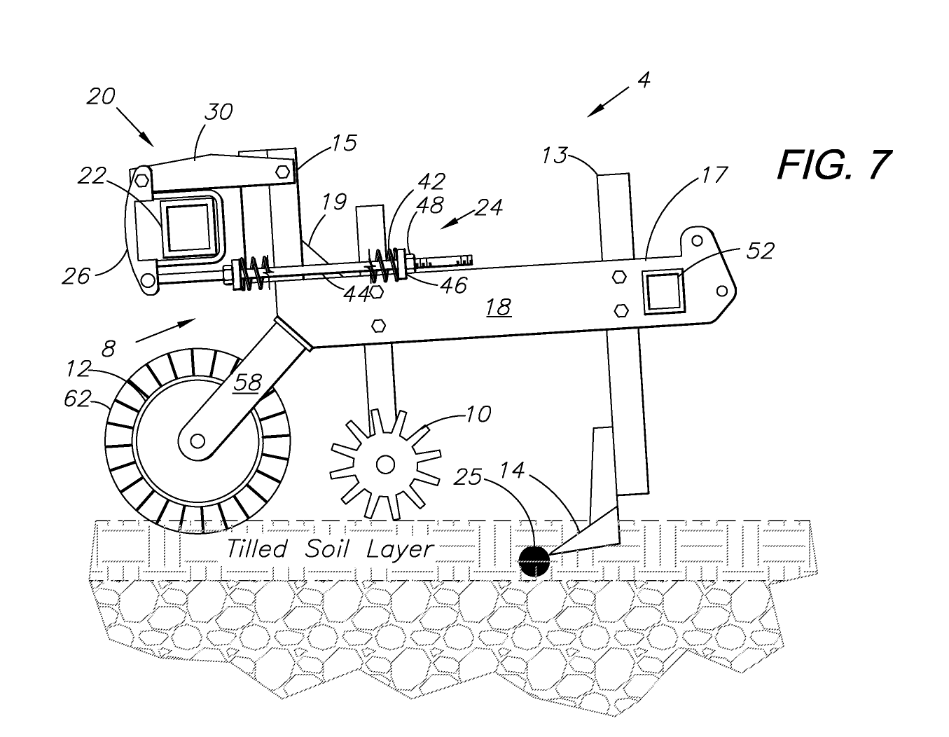

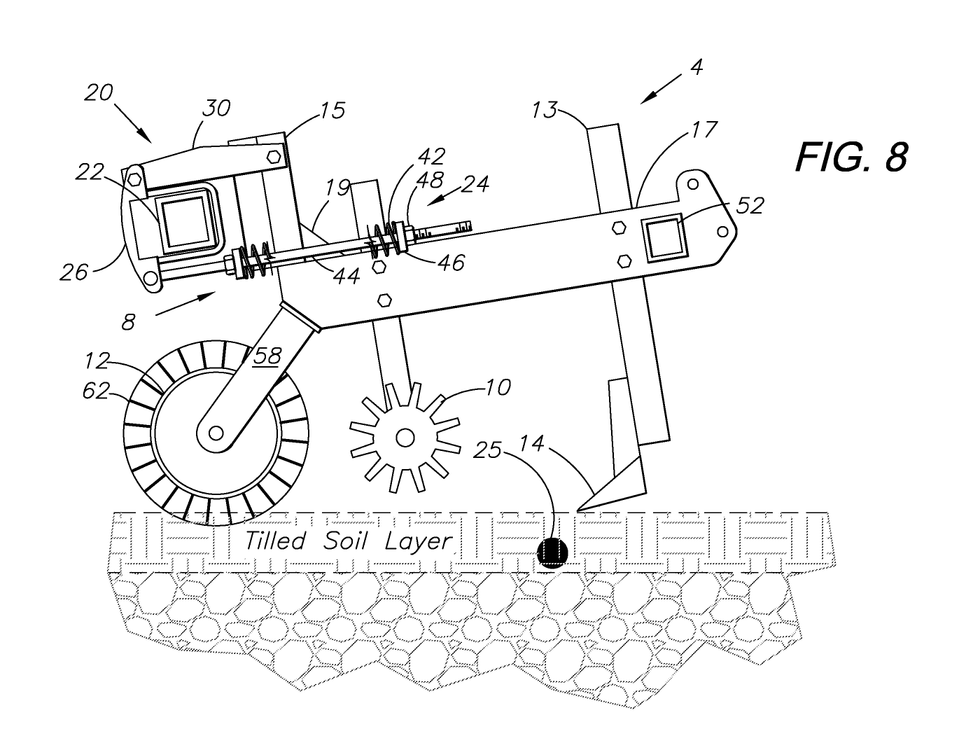

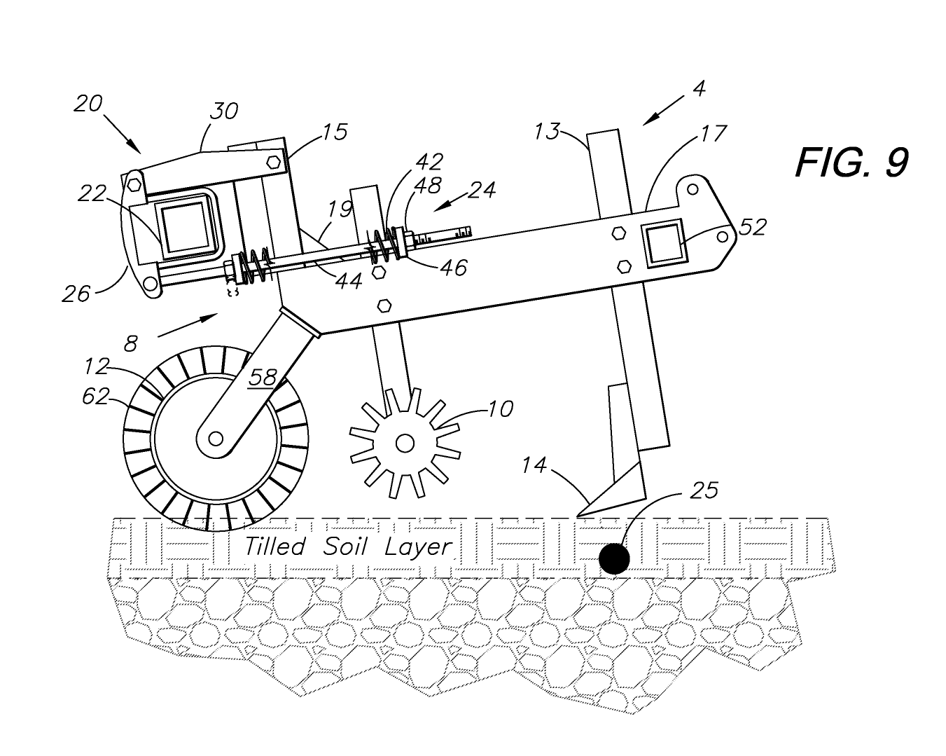

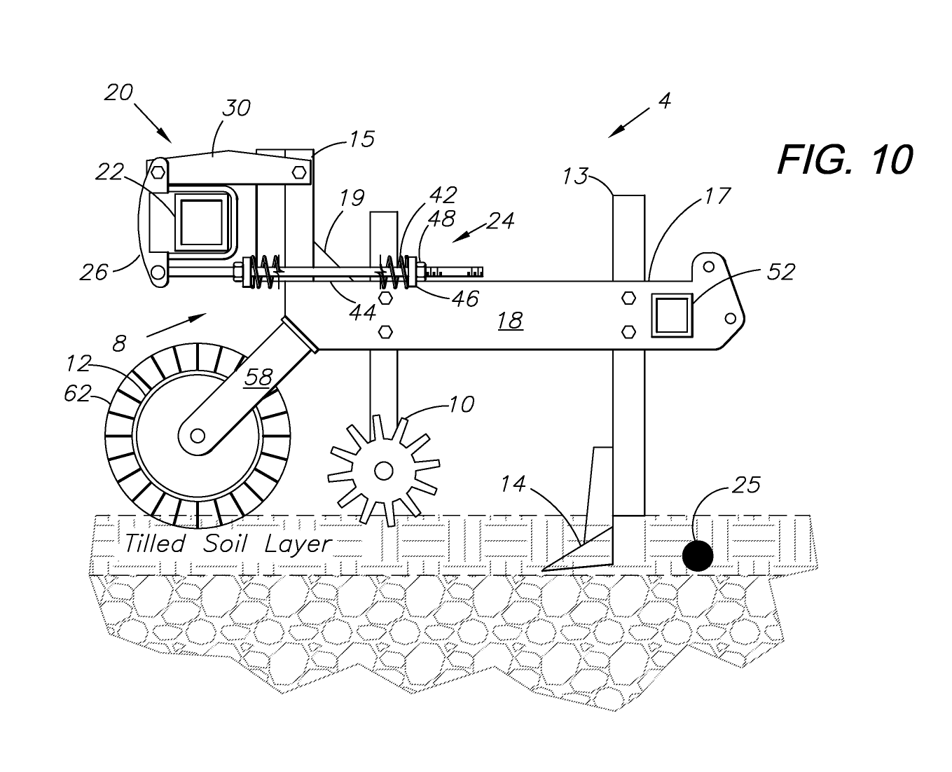

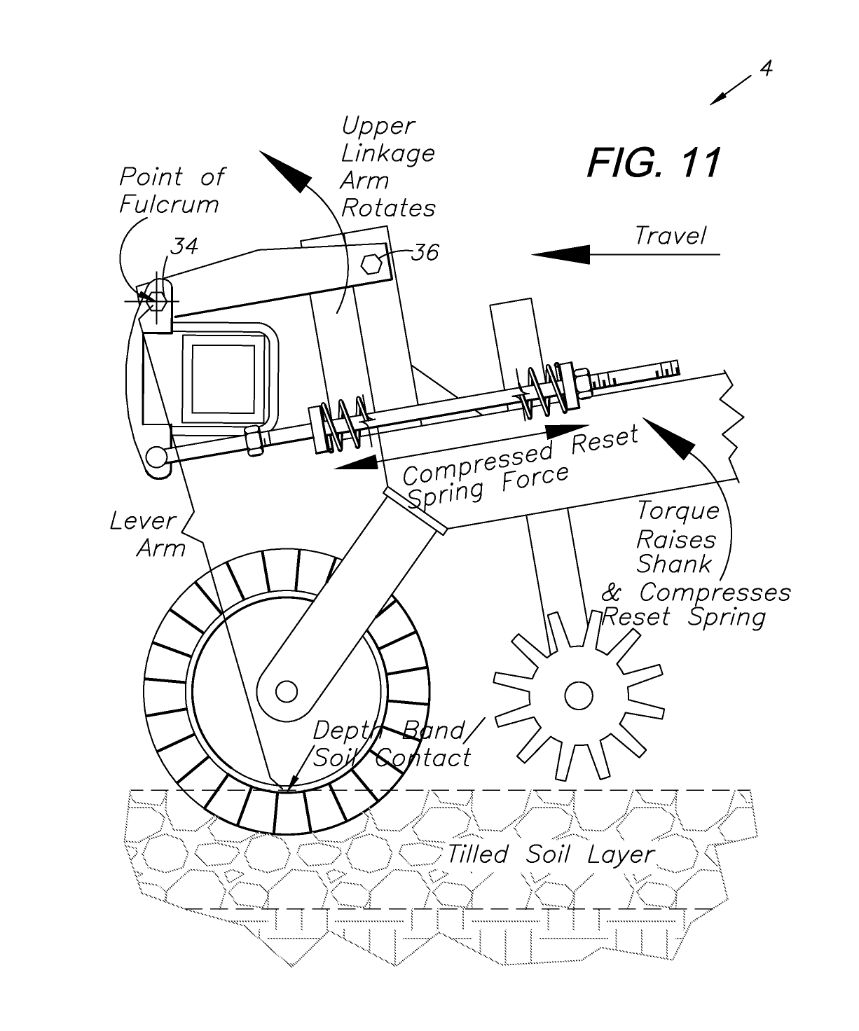

FIG. 4 shows the tillage tool arm assembly 4 in normal operation with the knife 14 embedded in the ground and the depth gauge wheel 12 maintaining the depth of the knife 14. A subsurface obstacle 25, shown in FIGS. 5-10, is located in front of the knife 14 and generally in its path. FIG. 5 shows the depth gauge wheel 12 passing over the obstacle 25. FIG. 6 shows the row cleaners 10 clearing the obstacle 25. FIG. 7 shows the knife 14 hitting the obstacle 25, causing the tool arm 18 to rotate counterclockwise, as shown further in FIGS. 8 and 9, and again in more detail in FIG. 11.

An attachment bar receiver 52 is located at the proximal end of the proximal section 17 of the tool arm 18. This receiver allows for connection of additional ground-working tools in the form of a secondary tool attachment 54, such as shown in FIG. 4. A spring-loaded absorber 56 connects the main arm 66 of the secondary tool attachment 54 to a mounting bracket assembly 60 similar to bracket assembly 20 discussed above. In the example shown, a secondary coulter blade 62 and tilling tool 64 are connected via the secondary tool attachment 54, and would be lifted by the reset spring assembly 24.

### III. Conclusion

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A tillage tool, which includes:
a toolbar adapted for connection to a vehicle;
a tool arm assembly comprising a tool arm including a proximate section with a generally vertical working position and a distal section with a generally horizontal working position;
a mounting bracket mounted on said toolbar and including a pivotal connection to said tool arm proximate section;
a reset spring assembly comprising a pair of coil springs each mounted on a respective torsion rod located on a respective side of said tool arm proximal section; and
said torsion rods pivotally connected to said mounting bracket and joining said mounting bracket to said tool arm.

2. The tillage tool of claim 1, further comprising:
said tool arm forming an elbow at a connection of said proximate and distal sections.

3. The tillage tool of claim 2, further comprising:
a knife mounted on a shank extending through a shank receiver affixed to the distal section of said tool arm;
a depth gauge wheel extending forwardly and downwardly from a wheel mounting plate affixed to said elbow; and
a row cleaner mounted to said tool arm between said depth gauge wheel and said shank.

4. The tillage tool of claim 3, further comprising a coulter disk mounted to said wheel mounting plate.

5. The tillage tool of claim 1, further comprising:
said mounting bracket further comprising a pair of bracket mount plates; and
each of said pair of bracket mount plates including a notch configured to receive said toolbar.

6. The tillage tool of claim 5, further comprising:
an upper linkage arm subassembly including a pair of linkage arms each pivotally connected at a first end to a respective said bracket mount plate by a first pivot bolt;
said pair of linkage arms each pivotally connected at a second end to the proximate section of said tool arm by a second pivot bolt; and
wherein said tool arm is configured to pivot about a pivotal axis through said second pivot bolt.

7. The tillage tool of claim 5, further comprising a pair of U-bolts removably mounting said mounting bracket to said toolbar.

8. The tillage tool of claim 1, further comprising:
said reset spring assembly including a spring mounting bracket pivotally attached to said proximate section of said tool arm by a bolt retainer.

9. The tillage tool of claim 8, further comprising:
said torsion rods extending through respective spring guides which threadably receive nuts configured to adjust tension within a respective coil springs.

10. The tillage tool of claim 1, further comprising at least one working tool selected from the list comprising:
knife, depth gauge wheel, coulter disk, row cleaner, and shank.

11. A method of operating a tillage tool comprising the steps:
drawing a tillage tool through a field with a vehicle, said tillage tool comprising a tool bar removably connected to said vehicle, said tillage tool further comprising at least one tool arm assembly;
each said tool arm assembly including a tool arm comprising a proximate section with a generally vertical working position and a distal section with a generally horizontal working position, said proximal and distal sections joining at an elbow;
said tool arm assembly pivotally mounted to said toolbar by a mounting bracket and a reset spring assembly comprising a pair of coil springs each mounted on a respective torsion rod located on a respective side of said tool arm proximal section;
working said field with a working tool comprising at least a knife mounted on a shank extending through a shank receiver affixed to the distal section of said tool arm;
contacting a subterranean obstacle with said working tool;
rotating said tool arm assembly about said toolbar from a first position to a second position due to contact with said subterranean obstacle, thereby compressing said coil springs; and
resetting said tool arm assembly from said second position to said first position by extending said coil springs.

12. The method according to claim 11, wherein the tillage tool further comprises:
a knife mounted on a shank extending through a shank receiver affixed to the distal section of said tool arm;
a depth gauge wheel extending forwardly and downwardly from a wheel mounting plate affixed to said elbow; and
a row cleaner mounted to said tool arm between said depth gauge wheel and said shank.

13. The method according to claim 12, wherein the tillage tool further comprises a coulter disk mounted to said wheel mounting plate.

14. The method according to claim 11, wherein the tillage tool further comprises:
said mounting bracket further comprising a pair of bracket mount plates; and
each of said pair of bracket mount plates including a notch configured to receive said toolbar.

15. The method according to claim 14, wherein the tillage tool further comprises:
an upper linkage arm subassembly including a pair of linkage arms each pivotally connected at a first end to a respective said bracket mount plate by a first pivot bolt;
said pair of linkage arms each pivotally connected at a second end to the proximate section of said tool arm by a second pivot bolt; and
wherein said tool arm is configured to pivot about a pivotal axis through said second pivot bolt.

16. The method according to claim 14, further comprising the step:
removably mounting said mounting bracket to said toolbar with a pair of U-bolts.

17. The method according to claim 12, wherein the tillage tool further comprises:
said reset spring assembly including a spring mounting bracket pivotally attached to said proximate section of said tool arm by a bolt retainer.

18. The method according to claim 17, wherein the tillage tool further comprises:
said torsion rods extending through respective spring guides which threadably receive nuts configured to adjust tension within a respective coil springs.
